(19) United States
(12) Patent Application Publication
(10) Pub. No.: US 2024/0267416 A1
(43) Pub. Date: Aug. 8, 2024

(54) CONTENT DISCOVERY THOUGH PROMPTS

(71) Applicant: Sonos, Inc., Santa Barbara, CA (US)

(72) Inventors: Selena YANG, Riverside, CA (US); Sein WOO, Whittier, CA (US); Bona KIM, Boston, MA (US)

(21) Appl. No.: 18/430,181

(22) Filed: Feb. 1, 2024

Related U.S. Application Data
(60) Provisional application No. 63/483,733, filed on Feb. 7, 2023.

(51) Int. Cl. H04L 65/1066

(52) U.S. Cl. CPC H04L 65/1066

(57) ABSTRACT

Techniques for sharing content via prompts are disclosed. In some techniques, prompts are provided via user devices. Users can respond to the prompts with an indication of at least one media content item. The responses to prompts can be shared among various users so that users can see and optionally play back the media content indicated in the responses to the prompts. In this way, users can add, see and sample content shared by multiple users and from multiple content sources.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIG. 2 illustrates a block diagram of an example system in which content sharing via prompts could be implemented, in accordance with some embodiments described herein.

FIG. 3 illustrates a set of flowcharts for example methods of sharing content via prompts, in accordance with some embodiments described herein.

FIG. 4 illustrates example user interfaces that can be displayed during an example content sharing via prompts process, in accordance with some embodiments described herein.

FIG. 5 illustrates an example user interface including prompt responses, in accordance with some embodiments described herein.

FIG. 6 illustrates additional example user interfaces, in accordance with some embodiments described herein.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

People share content in multiple scenarios, whether it is for informational purposes, for business, or simply for personal enjoyment. With the popularity and widespread usage of social media and other content sharing and crowdsourced platforms, people are more and more likely to rely on these resources for recommendations (e.g., where to go, what to do, what to buy, etc.). However, providing a content sharing platform that is organic and built out of authentic content recommendations continues to be a challenge.

Furthermore, most content sharing platforms do not provide straightforward options to organize and/or categorize content. The immense amount of content available can be difficult to filter down by specific topics or purposes, and the speed and volume at which content is shared sometimes causes results relevant to a specific search to be lost among a large number of results. Additionally, most content sharing platforms are not specific to a certain kind of content. Users typically share unrelated content via the same platform (e.g., personal pictures, news, travel or jobs updates, recommendations, etc.), which can be overwhelming and/or not useful for specific purposes.

When it comes to sharing restricted access content, such as paid content or content that can be accessed based on a subscription or membership, there can be additional challenges. For example, a subscriber of a particular service can share content provided by the particular service in a social media platform. Other users of the social media platform can see the post, but may not be able to access the content because they are not subscribed to the particular service that provides the content in the first place. An example of such scenario would be sharing media content, such as audio and/or video content, which is provided by a media streaming service for which a subscription is needed.

Sonos Inc., has proposed some solutions to overcome these or similar issues, such as the solutions described in U.S. Pat. No. 9,286,384, filed Sep. 21, 2011, entitled “Methods and systems to share media”, U.S. Pat. No. 10,331,736, filed Mar. 21, 2014, entitled “Facilitating streaming media access via a media-item database”, U.S. Pat. No. 10,129,599, filed Apr. 28, 2014, entitled “Media preference database”, U.S. Pat. No. 9,510,055, filed Jan. 23, 2013, entitled “System and method for a media experience social interface”, U.S. Pat. No. 11,190,564, filed Nov. 19, 2020, entitled “Multimedia content distribution system and method”, U.S. Pat. No. 9,874,997, filed Aug. 8, 2014, entitled “Social playback queues”, the contents of which are incorporated by reference herein in their entireties.

However, there continues to be a need for a content sharing platform that provides more flexibility in integrating different content sources, thereby enabling and encouraging users to try and sample content from multiple sources in a way that is appealing and promotes user engagement. Furthermore, there is a need for a content sharing platform that collects, organizes and/or indexes content in an intuitive manner, so that users can share and search specific content and/or related content with ease.

Aspects of this disclosure relate to methods and systems for sharing content. More specifically, some embodiments relate to content sharing using prompts. In accordance with some embodiments disclosed herein, prompts can be and/or comprise statements to be provided to users (so that users are “prompted” with the statement). Prompts can include any kind of statements. For example, prompts can include statements about user preferences, user personal data, user behavior, user contextual information, etc. In some instances, prompts include statements related to media content. For example, prompts can include statements such as “my favorite artist is”, “my go to commute radio station is”, “my morning podcast is”, “this holiday I will be listening to” etc. Prompts can also include and/or be in the form of questions or any other format. The statements can comprise questions or phrases to which users can respond indicating related content. The content can be any kind of content such as books, places, digital content, etc. In some embodiments described herein, the content comprises one or more media content items such as songs, audio books, podcasts, videos, etc. that can be played back by a playback device.

In some instances, users can add, share, view and interact with recommendations via prompts. For example, users can be provided with the prompt “A song that makes me dance is: ”. One or more users could respond to this prompt indicating a song that makes them dance. This indication would be a genuine representation of the user's musical taste. These responses can then be shared with other users that would then have authentic recommendations of songs that make people dance. A user putting together a playlist for a party could rely on such recommendations in order to gather songs that most likely guests will like. For example, the user could review the prompt responses from friends coming to a party, and create a playlist containing the same or similar songs as indicated by the friends.

Prompts can be provided to the users in various ways. In some instances, prompts can be in the form of or otherwise comprise visual/graphical representations corresponding to the statement. The graphical representations can be displayed via any device that comprises means to display visual/graphical representations (e.g., a display) including any user device that comprises a display (e.g., a smartphone, a computer, a TV, etc.), a playback device that comprises a display, etc. In some instances, prompts can be in the form of or otherwise comprise auditory messages corresponding to the statement. The auditory messages can be played back via any device that comprises means to reproduce auditory messages (e.g., a speaker), including any user device (e.g., a smartphone, a computer, a TV, etc.), a playback device, etc.

In some instances, users can provide responses to the prompts. For example, users can respond with indications of content (e.g., an indication of a media content item such as a song). In some instances, users can share their responses to the prompts with other users. In this way, other users can access prompt responses to obtain authentic content recommendations originated from genuine user responses to the prompts. For example, a user could search a collection of responses to a prompt “the best movie of all times is” to identify movies that other users like and/or any related trends. As another example, a user could search a friend's profile to identify content (e.g., music) that the friend likes and/or recommends in a variety of topics, similarly to browsing their friend's record collection.

In some instances, a platform and/or service is provided through which prompts can be shared. Users of this platform/service can access the prompts, respond to the prompts, share their responses, see and/or interact with responses by other users, etc. This platform/service can integrate and/or have access to multiple content sources so that users can refer to/indicate content from multiple sources when responding to the prompts. In some instances, the platform/service can be accessed via an application installed on a user device, a web interface, or the like. In some instances, the platform/service can be provided by a media playback system provider such as SONOS. For example, the platform/service could be accessed via an application such as the controller application for a media playback system described before in this disclosure.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

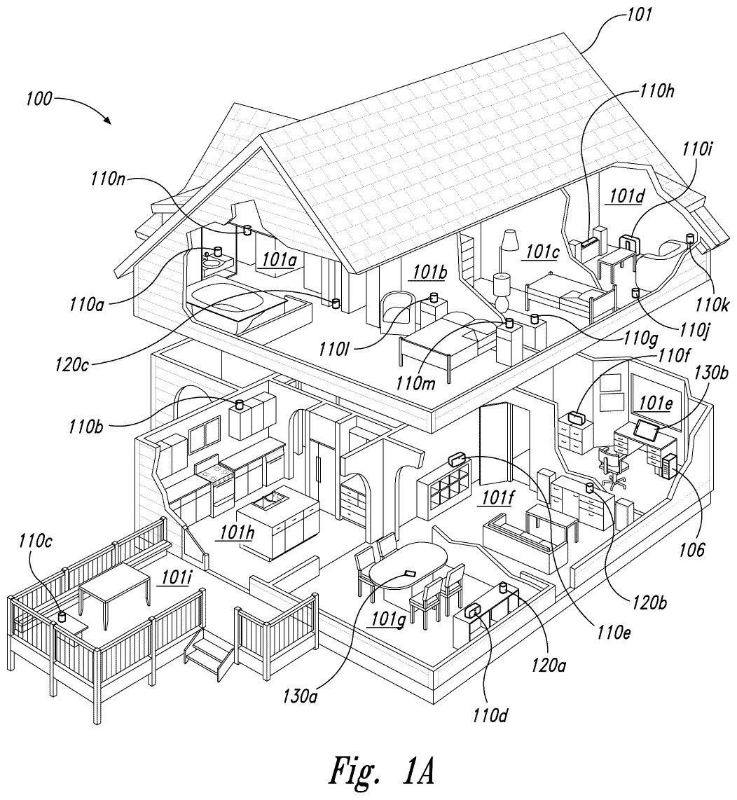

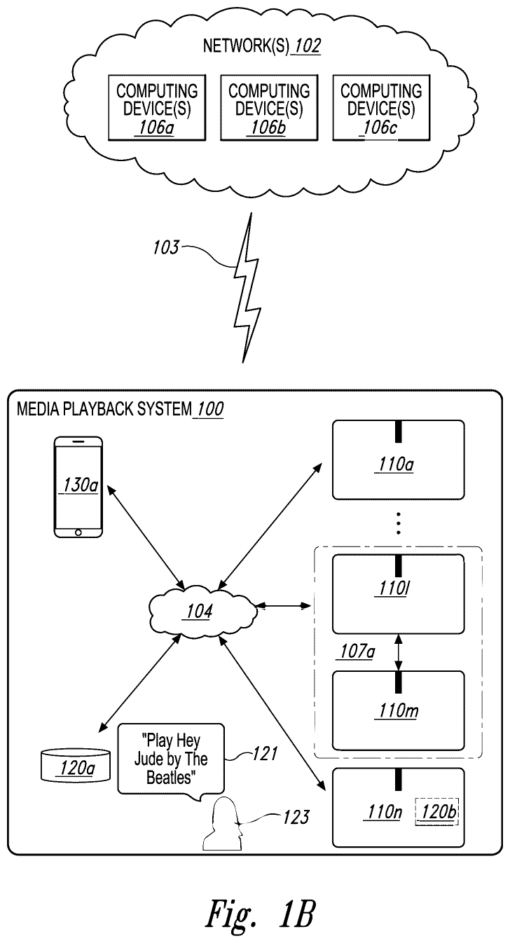

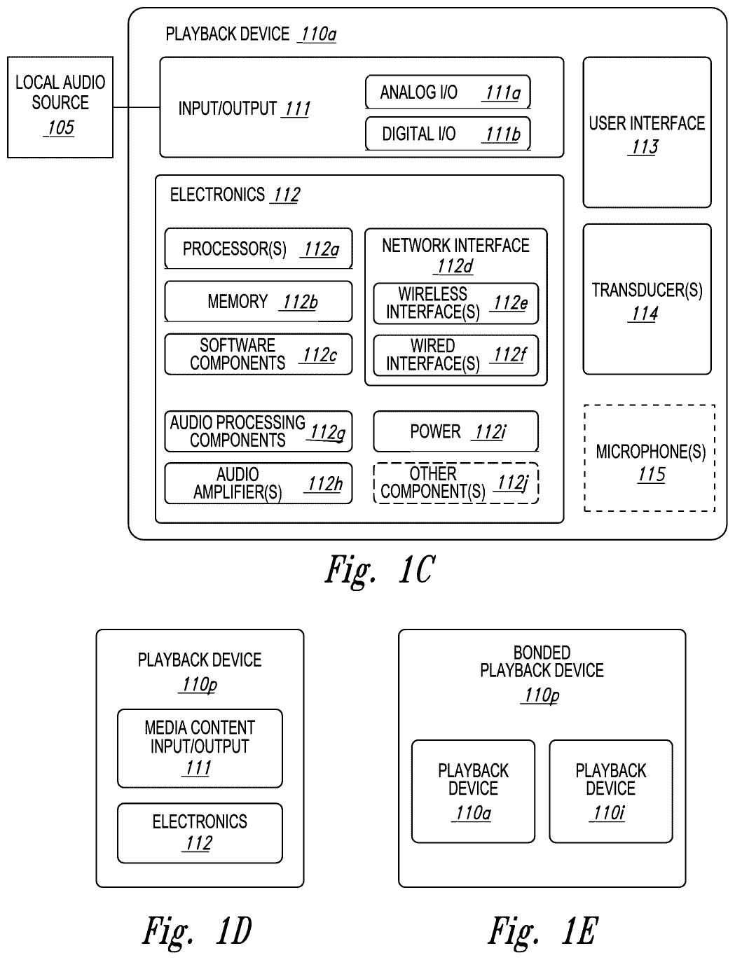

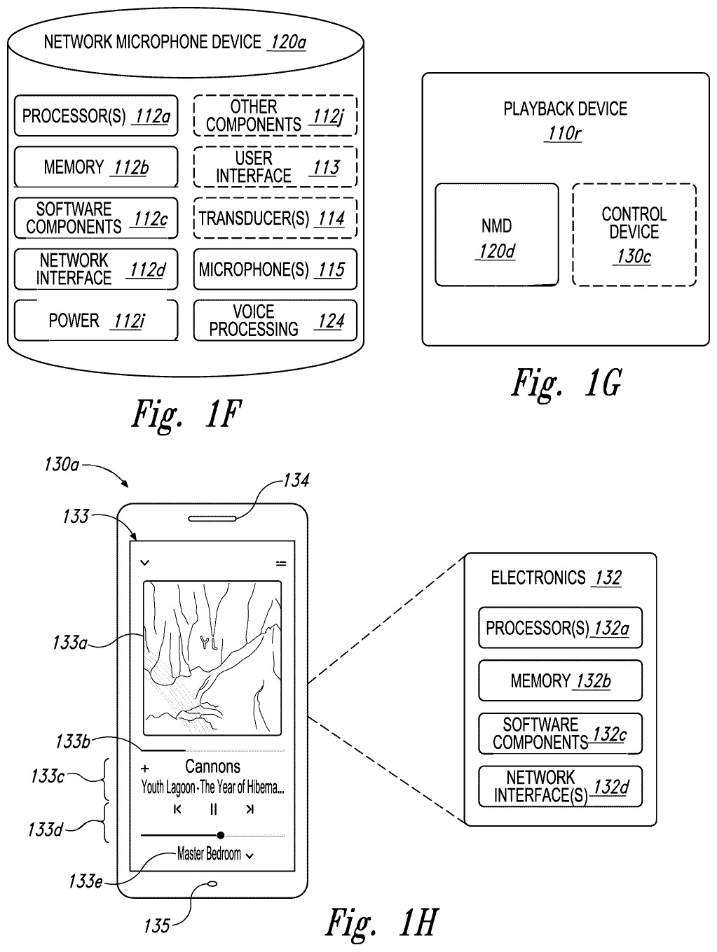

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE ® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. Content Discovery Though Prompts

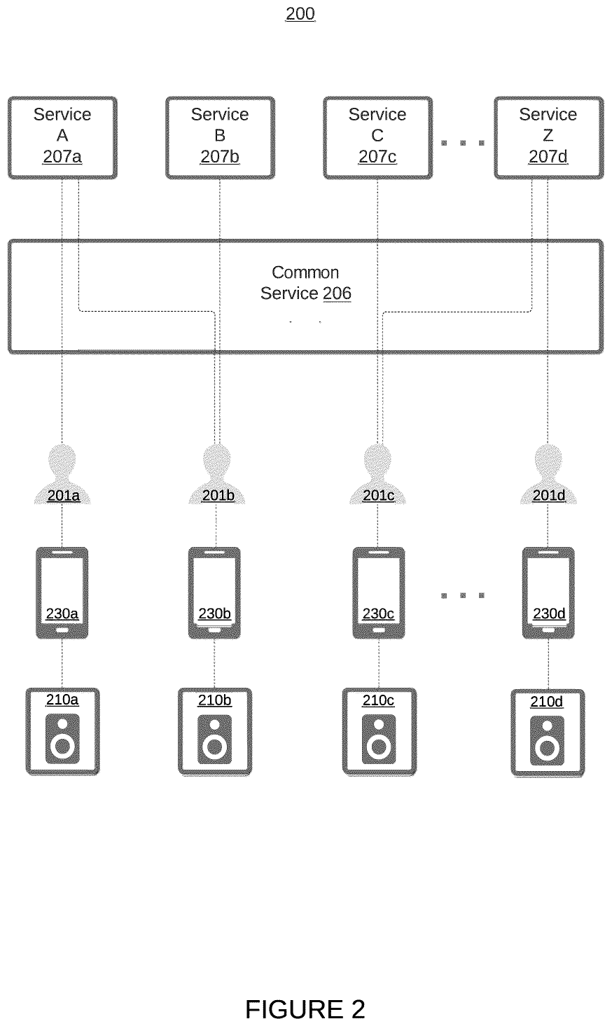

FIG. 2 illustrates a block diagram 200 of an example system in which content sharing via prompts can be implemented, in accordance with some embodiments described herein. FIG. 2 illustrates a set of users 201a, 201b, 201c, and 201d (collectively referred to as users 201). Although only four users are illustrated in this diagram, the system could include any number of users. Users 201 can each be associated with (e.g., own or otherwise be a user of) a media playback system such as media playback system 100 described with reference to FIGS. 1A-1H. As described before in this disclosure, the media playback system could include one or more control devices, such as user devices 230a, 230b, 230c and 230d (collectively referred to herein as control devices/user devices 230) and one or more playback devices, represented by playback devices 210a, 210b, 210c and 210d (collectively referred herein as playback devices 210).

Users 201 can each be subscribed to, registered with, or otherwise associated with a common service 206. Common service 206 can be any kind of service such as a social media and/or any content sharing platform. In some instances, common service 206 can be a dedicated service which users subscribe to or register with in order to share content (e.g., to access and interact with prompts in accordance with some embodiments described herein). In some instances, common service 206 is a service used for other purposes (e.g., an application used for other purposes such as a game, a smart home management app/service, etc.) that can additionally be used to share content (e.g., prompts).

In some instances, the common service 206 can include a media playback system service of the media playback system that the users own or are associated with. For example, the media playback system service could be a service used by the users to manage certain aspects of their respective media playback systems, such as to configure and/or control their media playback systems, search content for playback, etc. An example of the common service 206 is the service/platform that Sonos, Inc. provides to all Sonos users to setup and manage their Sonos systems, which can be accessed via a controller application and/or a web portal on a user device. The common service can be implemented by a computing system. The computing system can be a cloud computing system and/or comprise one or more computing devices (e.g., servers, databases, etc.), such as computing devices 106a-c described with reference to FIG. 1B.

In some instances, users 201 can be associated with the service 206 (e.g., registered, subscribed) by creating an account with the service. The account can be an account with the media playback system provider. In some instances, users 201 can be associated with the service 206 when they setup their media playback systems. For example, users can be prompted to create an account with the service as part of a setup process for the media playback system. Example setup processes are described in U.S. Pat. Pub. 2022/0104015, filed Sep. 24, 2021, entitled “Intelligent setup for playback devices”, the contents of which are incorporated by reference herein in their entirety.

Users 201 could also be individually and independently subscribed to or otherwise associated with one or more additional services 207a, 207b, 207c, and 207d (collectively referred to herein as additional services 207). Additional services 207 can be any kind of services, including media streaming services and/or media storage services. In some instances, some or all services 207 are third party services, independent of the common service 206. In some instances, some or all services 207 are services offered by, or related to, the common service 206. In some instances, the additional services 207 can include a service to which users can subscribe through, but independent of, their association with the common service 206. For example, the common service 206 could include the general SONOS service provided to all users of a SONOS media playback system, while an additional service 207 could comprise a SONOS Radio subscription for particular users that subscribe to this service specifically.

Users 201 can subscribe to the additional services 207 directly with the providers of the services, independent of any association with the common service 206. For example, users can become subscribers of a media streaming service even before becoming users of the media playback service 206. As illustrated in FIG. 2, users can be subscribed to different services. For example, user 201a can be subscribed to Service A, but not to services B, C and D. User 201b, in turn, can be subscribed to both services A and B, but not to C and D. The example illustrated in FIG. 2 is non-limiting and used only to illustrate that different users can subscribe to multiple independent services in addition to the common service 206. All users in this set of users 201 can, however, be a user of the common service 206. For example, all users 201 can be users of a media playback system that grants access to the common service 206. As another example, all users 201 can be subscribed to/registered with the common service 206, independent of owning or being associated with any media playback system.

In some instances, the additional services 207 can be associated with the common service 206. For example, users can link their media streaming service accounts (as an example account with any of services 207) with an account of the media playback system (as an example account with the common service 206). Examples of how to create this association are disclosed in U.S. Pat. No. 8,910,265, filed Sep. 28, 2012, entitled “Assisted registration of audio sources”, the contents of which are incorporated by reference herein in their entirety.

In accordance with some embodiments described herein, by being associated with common service 206 users can share content via prompts and/or prompt responses. Prompts can be provided to users 201 via common service 206 so that users can respond and optionally share their responses with other users 201. As explained before in this disclosure, prompt responses provided by users 201 can include indications of media content that other users 201 can see and/or interact with. In this way, some or all users 201 of common service 206 can see the content indicated by some or all other users 201 and optionally access such content (e.g., play back a song indicated by another user). Such prompts/prompt responses can include indications of media content available at any media streaming service and/or location.

In some instances, the media content indicated in a prompt response may be provided by a service (such as any of the services 207) to which a particular user/user account of service 206 accessing the prompt response may not have access to. For example, user 201b can share a prompt response indicating a media content item available at media streaming service B. User 201a may access the prompt (e.g., via their account with service 206), but may not be a user of media streaming service B (or otherwise not have media streaming service B associated with their common service 206 account). Therefore, user 201a may not have access to such media content item. However, in some embodiments, common service 206 can act as an intermediary between the different services 207 and/or the users. In this way, common service 206 can provide at least part (e.g., a sample) of the media content item indicated in a prompt response, even when the user account with service 206 is not associated with the media streaming service B that provides/stores the media content item (e.g., when users are not subscribed to the media streaming service that provides and/or stores the media content item). In this way, users of different services can sample and/or enjoy media content from multiple sources via the common service 206.

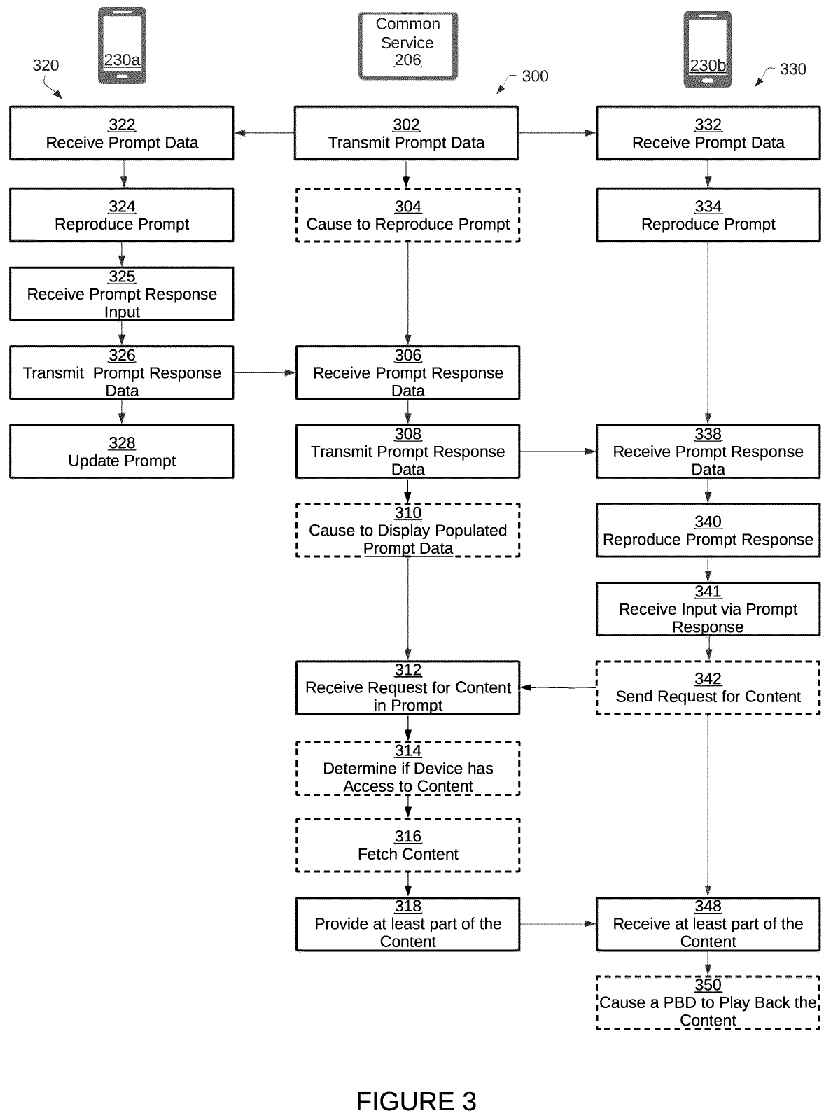

FIG. 3 illustrates a set of flowcharts for example methods of sharing content via prompts. The blocks in the flowcharts can be performed by various devices and/or systems, such as the various devices/systems represented in FIG. 2. In the specific example illustrated in FIG. 3, some or all of the blocks in flowchart 300 can be performed by a service such as the media playback system service 206 of FIG. 2. This can be accomplished by a computing system (e.g., one or more computing devices) comprising one or more processors and one or more non-transitory computer-readable medium collectively comprising program instructions that are executable by the at least one processor such that the computing system is configured to implement the service and/or perform the blocks of the method. In some instances, some or all functionalities of service 206 can be instantiated locally on a user device such as any of user devices 230 so that any of the blocks of methods 300 can be performed by the user devices 230.

On the other hand, some or all of the blocks in flowcharts 320 and/or 330 can be performed by user devices such as the user devices 230 of FIG. 2. In the specific example illustrated in FIG. 3 and for explicative purposes only, a first control device (e.g., 230a) can perform some or all of the blocks in flowchart 320 and a second control device (e.g., 230b) can perform some or all of the blocks in flowchart 330. This can be accomplished by the devices comprising one or more processors and one or more non-transitory computer-readable medium collectively comprising program instructions that are executable by the at least one processor such that the devices are configured to perform the respective blocks of the methods.

Method 300 comprises a block 302 of transmitting a first set of data to a set of users/user devices. The set of users/user devices can comprise all or some of the users 201/user devices 230 of FIG. 2. For example, the set of users/user devices can comprise any user/user devices associated with (e.g., registered with) the service 206. In the illustrated example, the set of data is transmitted to device 230a and device 230b, but could be transmitted to any number of users/devices. The set of data can be stored in association with the user's accounts so that any device in which a user account is registered can access (e.g., download) the set of data.

In some instances, the first set of data transmitted in block 302 corresponds to a prompt to be reproduced (e.g., displayed, played back, etc.) by the set of user devices 230 and/or playback devices 210. For example, the first set of data can comprise the prompt itself (such as graphical representation, an auditory message, etc.) to be reproduced by the respective devices. As another example, the first set of data can comprise data for the user devices to generate the prompt (e.g., instructions, commands, text or audio data, etc.). As another example, the first set of data can comprise data to access the prompt, such as a link to the prompt, a URI and/or URL, etc., so that the user devices can use the received set of data to fetch the prompt or additional data to generate the prompt. The user devices (such as user devices 230a and 230b in the example of FIG. 3) receive the first set of data (as indicated in blocks 322 and 332 of flowcharts 320 and 330, respectively).

In some instances, before transmitting the first set of data in block 302, method 300 can comprise additional blocks of receiving the prompts/prompt data to be sent to the users/user devices. For example, the service 206 can receive the prompts/prompt data from a service administrator, or from any other sources such as from the Internet or from another service. In some instances, users can create/request prompts. In those instances, the service 206 can receive the prompts/prompt data from other users 201/user devices 230. Alternatively, users can send prompts/prompt data directly to other users/user devices so that block 302 of flowchart 300 can be instead conducted by a user device sending the prompt data to other user devices.

In some instances, before transmitting the first set of data in block 302, method 300 can comprise additional blocks of generating the prompts/prompt data to be sent to the user devices. For example, the service 206 can be configured to generate prompts at a certain frequency (e.g., once a day, once a week, every season, for certain holidays, etc.). The service can be configured to gather/use contextual information to decide which prompts to generate. For example, the system can be configured to determine trending topics online and generate prompts related to such trending topics.

In some instances, the service 206 operates in association with a library of prompts so that prompts sent in block 302 are fetched from the library (e.g., randomly selected or selected based on a specific criteria). The library of prompts can be maintained by service administrator(s) and/or users 201 that can contribute and/or suggests prompts or topics for prompts. The library of prompts could also be assisted by artificial intelligence software that generates or suggests prompts.

Prompts can be designed in various ways. For example, prompts can include colors (e.g., background color, text color, etc.), images, sounds, videos, etc. The prompt data transmitted to user devices in block 302 can include data related to the appearance of the prompt and/or the way the prompt is to be reproduced. For example, the prompt data can include instructions that cause the user device to reproduce the prompt in a particular way (e.g., font type, font size, font color, arrangement, etc.). In some instances, the appearance of the prompt can be customized for individual users. For example, prompts can be customized so that they match a user device theme or based on user's preferences. As another example prompts can be customized to specific topics such as holidays, events, etc.

Method 300 comprises an optional block 304 of causing the user devices 230 to reproduce the prompts. This block can include sending instructions to the user devices to reproduce the prompts, and can include causing the user devices to display a graphical representation of the prompts, or to play back an auditory message corresponding to the prompt, etc. In some instances, execution of block 304 is intrinsic to the execution of block 302 in that sending the prompt data could intrinsically include an instruction for the user devices to reproduce the prompts.

In some instances, block 304 is not performed and the service 206 does not instruct the user devices to reproduce the prompts. Instead, block 302 is a passive step that does not cause the user devices to take any action unless something else happens (for example unless a user input is received to visualize/listen to the prompt). In any case, flowcharts 320 and 330 respectively include blocks 324 and 334 of reproducing the prompts (e.g., displaying or playing back the prompt).

Blocks 324 and 334 of reproducing the prompts can be conducted in response to receiving the prompt data in blocks 322/332. Blocks 324 and 334 could alternatively be conducted in response to receiving an instruction, for example in instances in which block 304 is performed. In some instances, the prompt can be reproduced automatically for the user. For example, the prompt can be reproduced (e.g., pop up) when the user opens a controller application of their media playback system.

In some instances, blocks 324 and 334 can be conducted in response to receiving a user input. For example, the prompts can be reproduced based on the user selecting a graphical indication on a display that causes the prompts to be displayed (e.g., selecting a “View Weekly Prompt” option on screen). In these instances, user devices 230 can receive the prompt data in blocks 322/332 and not display the prompt until the user explicitly takes an action to do so. In some instances, a dedicated user interface can be provided that comprises the prompts so that a user can go to such user interface when they desire to see the prompts. For example, a tab or button in a controller application of their media playback systems can comprise a “Prompts” option. When the users select such option, they can be redirected to a screen comprising the prompts and/or other data related to the prompts feature offered by service 206. Referring to discussions associated with block 302 above, in one case, the service 206 may not transmit the prompt data to a user device 230a unless the service 206 receives a request from a user via the user device 230a.

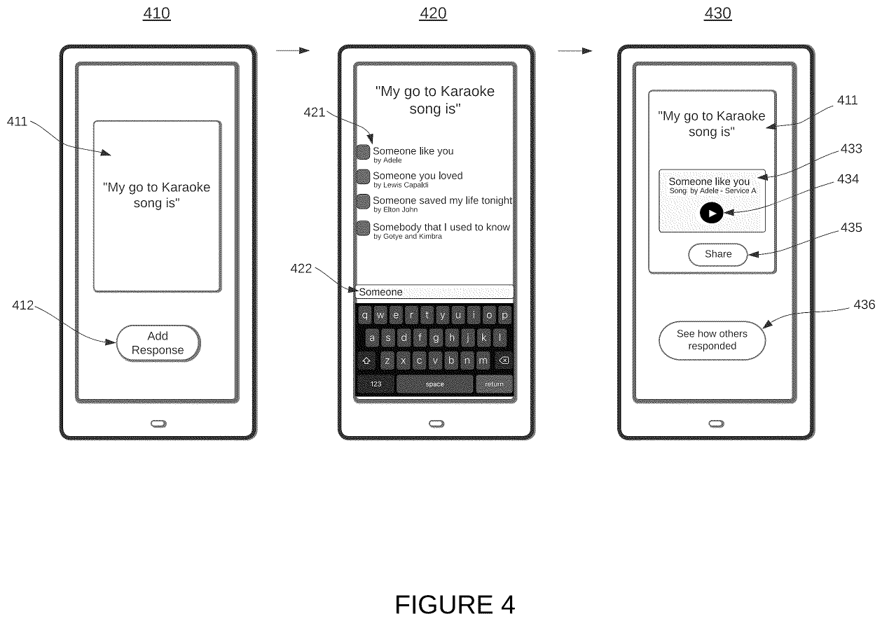

FIG. 4 illustrates example user interfaces that can be displayed during an example content sharing via prompts process. User interface 410 illustrates an example of a prompt that can be displayed as a result of the execution of blocks 324/334 in FIG. 3. In this example, the prompt 411 comprises the example statement “My go to karaoke song is”. As explained before, prompts can include any kind of statement and take any form (e.g., a question, a sound, an image, a video, etc.). In the illustrated example, a user could respond to the prompt by selecting selectable indication 412, which, when selected, could cause the user interface to be updated so that the user can provide a response.

Referring back to FIG. 3, flowchart 320 comprises a block 325 of receiving an input corresponding to a response to the prompt. The input can be received in various ways. For example, the input can be received via a display/touch screen, in the form of a selection on the screen. As another example, the input could be received via a microphone, in the form of a voice command. As another example, the input can be received via hardware control on a playback device (e.g., a button on a speaker, headphones, etc.). The input can comprise one or more user actions such as a selection of one or more buttons or icons on a screen, typing, gestures such as swiping and tapping, giving one or more voice commands, etc. In some instances, the input can be provided via the prompt itself, (e.g., by selecting a selectable indication on or near the prompt to respond, or by responding to an auditory prompt with a voice command, etc.).

In some instances, the input comprises an indication of at least one media content item. As explained before in this disclosure, prompts can be statements that promote sharing of media content that better suits the prompt in the user's opinion. In the example illustrated in FIG. 4, prompt 411 comprises the phrase “My go to karaoke song is”, which would, in most cases, result in the users responding to such prompt with an indication of a media content item being their favorite karaoke song. As explained, the user can interact with/respond to the prompt by, for example, selecting selectable indication 412. Selecting selectable indication 412 could, in some instances, result in the user interface being updated (e.g., to include elements of user interface 420) to facilitate the input of a response.

As illustrated in user interface 420 of FIG. 4, in this specific example the user can type (422) and/or select a media content item to be indicated with their response. In some instances, as the user types, options that match the search can dynamically appear on screen for the user to select from. Such options can be sourced from any of the services (e.g., services 207) that the user has associated with their media streaming service account. An indication of the service from which the media item is being presented can be provided on screen. For example, the first search result can be from service 207A while the second search result can be from service 207B, assuming the user is subscribed to both services 207 A and B. The user can then select the media content item that better suits their search to be used in the response to the prompt.

In some instances, prompt responses can be customized. For example, users can customize the appearance of the prompt response with different colors, patterns, images, etc. to further personalize the response. Customization inputs could be provided as part of the inputs provided in block 325 of flowchart 320. For example, the flow of interfaces shown in FIG. 4 could include selectable options to personalize at least one aspect of the prompt response. The customization data could be passed on to service 206 and/or other user devices so that other users can see the personalized prompt response.

In some instances, the user interface can be updated to illustrate the response to the prompt, as indicated in block 328 of flowchart 320 in FIG. 3 and represented in user interface 430 of FIG. 4. As illustrated, the updated user interface can include the prompt 411, an indication of the media content item indicated in the response 433, and a selectable indication 434, that, when selected, causes playback of at least part of the media content item by the user device or at least one playback device working in association with the user device.

In some instances, the prompt response data can be shared with the service 206 and/or other user devices, as indicated in block 326 of flowchart 320. Prompt data could be shared automatically when the user responds to the prompt. Users may be able to opt in/out of this feature by, for example, altering configuration settings (e.g., privacy settings) in their accounts. In some instances, a “share” option 435 can be provided on screen when the user responds to the prompt, as illustrated in user interface 430. At this point, the prompt response data could be shared with all other users 201 that are subscribers of service 206. Alternatively, the prompt response data can be shared with a subset of users 201 that are authorized to receive data from the user sharing the prompt response. For example, in some instances, only users that have previously being connected to (e.g., a via a friend request or other means) to the user sharing the prompt response can receive the prompt response from such user. As another example, only users that are following the user sharing the response could receive the prompt response. The user may also have the option to select which users should receive a given prompt response at the time of sharing the response or by altering configuration settings (e.g., privacy settings) in their account. Other options are possible. Prompt response data could be shared directly with other user devices 201 and/or via service 206 as an intermediary, as will be explained in more detail below with reference to blocks 306/308 of flowchart 300. Users can be provided with an option to see other user's responses. For example, a selectable indication such as selectable indication 436 in FIG. 4 could be provided which, when selected, causes the user interface to be updated to include prompt responses from other users.

Common service 206 can act as an intermediary between the different users/user accounts registered with common service 206 and/or the different additional services 207. For example, users 201 can share their prompt responses with other users via common service 206. Common service 206 can administer prompt responses so that users who receive them are able to at least sample the media content items indicated in the responses. In instances in which users/user accounts of common service 206 have access to the media streaming service that provides/stores the media content item indicated in a prompt response, common service can stream the media content item or cause the media content item to be streamed from the media streaming service to the user's device. In instances in which users/user accounts of common service 206 do not have access to the media streaming service that provides/stores the media content item indicated in a prompt response, common service 206 can still provide prompt response data in various ways so that users are able to enjoy the experience. For example, common service 206 could identify an equivalent media content item provided/stored by another media streaming service to which the user/user account does have access to. As another example, common service 206 could obtain samples (e.g., snippets) of the media content item from the media streaming service and provide such samples to the user devices. These and other approaches will be explained below in more detail.

Method 300 comprises a block 306 of receiving a second set of data from a user device. The second set of data can correspond to the response to the prompt received via user device 230a. As explained, such response can comprise an indication of at least one media content item. At this point, the service 206 could store such data and/or use it for other purposes such as for recommending content to the user or determining a user listening profile, etc. In some instances, the service 206 can transmit at least part of the response data to other users 201/devices 230 (for example based on a user's privacy configurations).

Method 300 comprises a block 308 of transmitting at least part of the second set of data to at least one other device (user device 230b in this example) in the set of user devices 201. The set of data can be transmitted to any number of devices to enable reproduction of the prompt response, such as to enable display of a graphical representation of the response to the prompt received via user device 230a. As with block 302, the set of data transmitted in block 308 can comprise the prompt response itself, data for the user device 230b to generate the prompt response, a link to the prompt response, etc. This data can be received by one or more user devices 201, as indicated in block 338 of flowchart 330.

Method 300 comprises an optional block 310 of causing the user devices 201 to reproduce the prompt responses. This block can include sending instructions to the user devices to reproduce the prompt responses, and can include causing the user devices to display a graphical representation of the prompt responses, or to play back an auditory message corresponding to the prompt responses, etc. In some instances, execution of block 310 is intrinsic to the execution of block 308 in that sending the prompt response data could intrinsically include an instruction for the user devices to reproduce the prompt responses.

In some instances, block 310 is not performed and the service 206 does not instruct the user devices to reproduce the prompt responses. Instead, block 308 can be a passive block that does not cause the user devices to take any action unless something else happens (for example unless a user input is received to visualize/listen to the prompt response). In any case, flowchart 330 includes a block 340 of reproducing the prompt responses (e.g., displaying or playing back the prompt response).

Block 340 can be conducted in response to receiving the prompt responses data in block 338 or in response to receiving the prompt response data from any other device 201. Block 340 could alternatively be conducted in response to receiving an instruction, for example in instances in which block 310 is performed. In some instances, the prompt response can be reproduced automatically for the user. For example, the prompt response can be reproduced (e.g., pop up) when the user opens a controller application of their media playback system.

In some instances, reproducing the prompt responses in block 340 comprises reproducing the prompt and an indication of the media content item indicated in the response to the prompt provided by user device 210a. In some instances, reproducing the response to the prompt comprises reproducing an indication of the user and/or account from which the response was received. In this way, when multiple responses to a prompt are received, users can have an indication of which users provided which response.

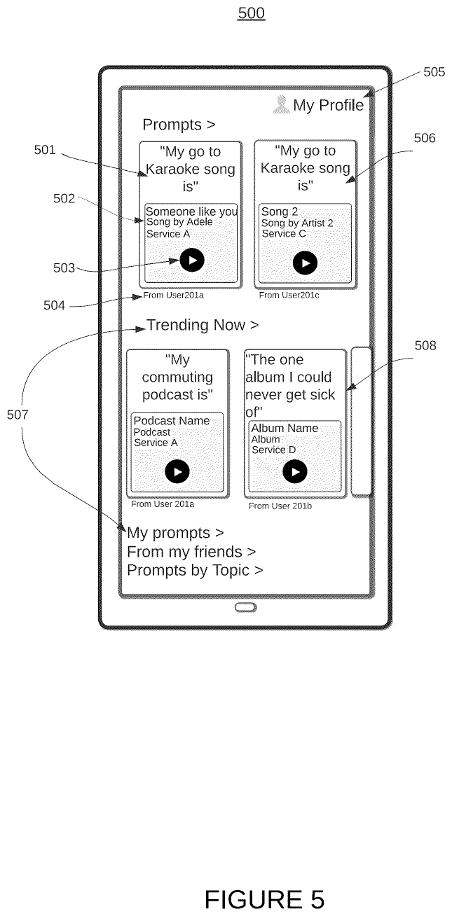

FIG. 5 illustrates an example user interface 500 including prompt responses. User interface 500 illustrates the response provided by user 201a. As illustrated in this example, the response includes the prompt 501, and the response 502 provided by user 201a. In this case, the response comprises an indication of the media content item indicated by user 201a. As shown, the indication of the response 502 may include metadata such as track title, track artist, and track album (including album art) corresponding to the media content, and an identification of the service from which user 201a selected the prompt response 502, among other possibilities. Additionally, it comprises an indication of the user and/or account that originated the response 504.

The prompt responses can comprise selectable indications that allow a user to interact with the prompt. Users can then provide inputs (e.g., a selection) via the prompt responses, as indicated in block 341 of flowchart 330. As illustrated in the example of FIG. 5, the response to the prompt can be reproduced in a user interface including a selectable indication 503 which, when selected, causes playback of at least part of the media content item. Playback can be by the user device in which the prompt is being reproduced (e.g., smartphone), by at least one playback device in the media playback system such as playback device 210b, etc.

The user device 230b could receive at least part of the media content item from the service 206, as indicated in block 348 of FIG. 3. For example, the at least part of the media content item could have been received as part of the response data received in block 338 so that the user device 230b has the data locally stored. The data can be the portion of the media content item itself, an indication of the media content item, a link or address to the media content item, etc. In any case, the user device 230b can be able to fetch the portion of the media content item and reproduce it. The user device 230b could also request/receive the media content item from any other source, such as from any of the services 207. In some instances, when an input is received via the prompt that would cause playback of the media content item, a request can be sent to the service 206 and/or any of the services 207 that provides the media content item (e.g., via block 342).

Method 300 comprises a block 312 of receiving a third set of data corresponding to a selection received via the prompt response. The selection can be, for example, a selection of selectable indication 503 in FIG. 3 to play back the media content item indicated in the response. In instances in which this block is conducted, the service 206 could provide (e.g., steam) the at least part of the media content item to the user device 230b, as indicated in block 318.

In some instances, the service 206 could conduct a block 314 of determining whether the device and/or account requesting the media content item is authorized to access such media content item. For example, the service could verify whether the user is subscribed to/registered with the media streaming service 207 that provides such media content item. The service 206 could verify if the user account with the service 206 is associated with any service 207. The service 206 could very if the user/device is in possession of an access token to get the requested media content item. Based on such determination, the service could fetch the content in block 316 and provide it to the user device. In instances in which the user device does have access to the media content item (e.g., if the user is a subscriber of the media streaming service providing the item), the complete media content item could be streamed to the user device or the user device could be otherwise redirected to access the media content item from such service. In instances in which the user/user device does not have access to the media content item, the service 206 could provide at least a portion (e.g., a sample) of the media content item to the user device so that the user can still enjoy the prompts experience and sample content recommended by other users.

In some instances, the service could determine an equivalent media content item provided by a media streaming service that the user device 230b does have access to. In those instances, the service 206 could provide the equivalent version of the media content item to the device when a selection to play back the content in the prompt response is received. Examples of how to provide such equivalent version are provided in U.S. Pat. No. 9,286,384, which was incorporated by reference above.

With the processes described above, users can be able to sample content available at multiple sources from the same place, i.e., common service 206. Additionally, because prompts can be general statements that a big number of users can respond to, content can be organized and/or categorized in multiple ways such as by the topic of the prompts. In this way, users can be provided with a service/platform where they can access and/or sample authentic media content recommendations and filter down by user, by topic, type of content, or specific prompt. For example, a user can review all responses to a prompt such as “my party starter song is” to put together a party playlist made of authentic content recommendations.

User interface 500 of FIG. 5 includes various examples of prompts/prompt responses. As illustrated, a user could access such responses from their accounts/profile 505 with service 206. In some instances, the account/profile can be associated with a user or group of users (for example all users of a media playback system with an account of service 206). In other instances, each user can have their own account and/or profile even if they are associated with the same media playback system (e.g., different users of the same household can have their own account and/or profile to access/share prompts).

As illustrated in interface 500, multiple responses to the same or different prompt can be provided. For example, prompt response 506 comprises a response to the same prompt 501 by a different user 201c. Other prompts/prompt responses such as 508 can be provided via the same or different page or user interface, and can be related to different content. Prompts can be organized in multiple ways, for example by tags, hashtags, or the like. In the illustrated example, different tabs 507 are provided to group and/or organize prompts. In some instances, selectable tabs could be selected to expand a collection of prompts/prompt responses related to the tab.

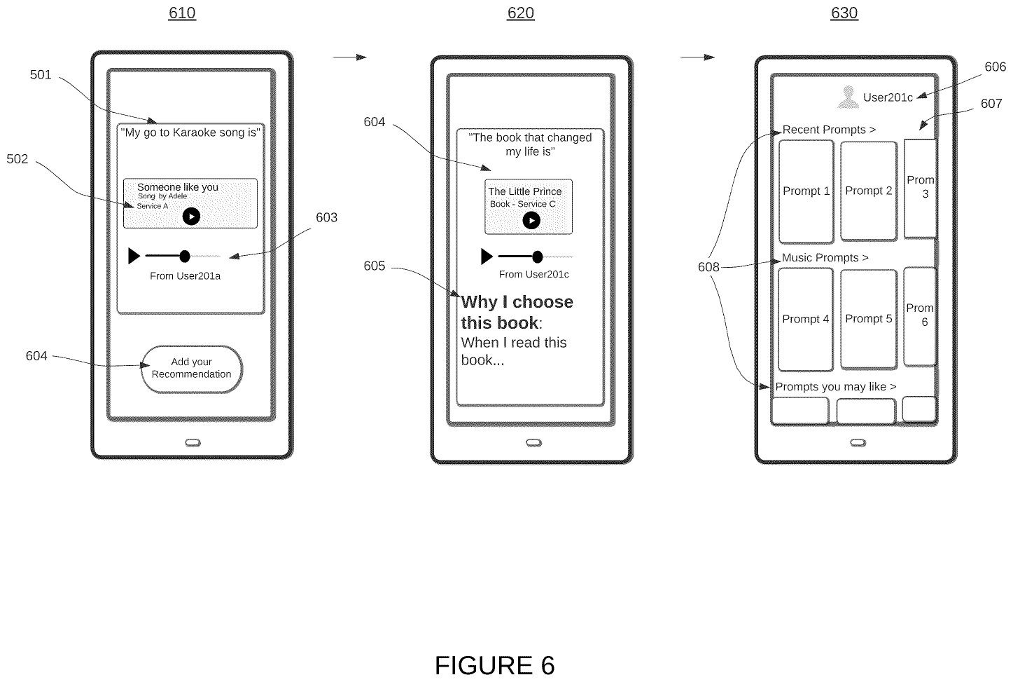

FIG. 6 illustrates additional example user interfaces, in accordance with some embodiments described herein. Interface 610 is an example of an interface that could be provided when a user selects a prompt (e.g., one of the prompts of the interface 500 of FIG. 5). The prompt responses could be provided with any additional data and/or options to make the user experience more enjoyable. For example, a progress bar 603 could be provided to show progress when the user is listening to/sampling the content in the prompt response. As other examples, a video or picture related to the prompt response could be provided with the prompt response (e.g., a picture of the cover of an album or a book). Additional buttons can also be provided to allow the user to further interact with the prompt. In the illustrated example, button 604 could be provided so that, when selected, allows the user to add their own response to the prompt. Additionally, users could comment, react, share, etc. to the prompt responses from other users.

Interface 620 is another example of a prompt response that could be provided when a user selects a prompt. In some instances, users could scroll down, swipe left/right, click “next”, etc. to navigate between prompts (e.g., to go from interface 610 to interface 620). Interface 620 illustrates a different example prompt 604 and associated response comprising an indication of content. In some instances, prompts and/or prompt responses can include a description (e.g., description 605). Users can be provided with an option to add such description together with the indication of media content.

Interface 630 is another example of a prompt responses page that could be provided, for example, when a user enters another user's profile. Users can be able to search other user's profiles for recommendations in a similar way to searching an album or book collection at a friend's house. The profile can comprise all or some prompts 607 shared by the specific user and can be organized in various ways, for example by prompts topics, etc. In the illustrated example, prompts are organized by headers 608 and/or tabs that group prompts based on different criteria. As such, prompts can be indexed in various ways such as by a user profile, a topic, a type of prompt, a type of content, etc.

### IV. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A computing system comprising:
at least one processor; and
at least one non-transitory computer-readable medium comprising program instructions that are executable by the at least one processor such that the computing system is configured to:
transmit a first set of data to a set of user devices, the first set of data corresponding to a prompt to be displayed by the set of user devices;
receive, from at least one first user device in the set of user devices, a second set of data, the second set of data corresponding to a response to the prompt received via the at least one first user device, wherein the response comprises an indication of at least one media content item;
transmit at least part of the second set of data to at least one second user device in the set of user devices to enable display, by the at least one second user device, of a graphical representation of the response to the prompt received via the at least one first user device;
receive, from the at least one second user device, a third set of data corresponding to a selection received via the graphical representation; and
based on the third set of data, stream at least part of the media content item to the at least one second user device.

2. The computing system of claim 1, wherein:
the set of user devices are registered with respective computing system accounts; and
the graphical representation of the response to the prompt comprises an indication of a computing system account associated with the at least one first user device.

3. The computing system of claim 1, wherein:
the at least one first user device is registered with a first media streaming service; and
the media content item is stored in a storage of the first media streaming service.

4. The computing system of claim 3, wherein the at least one non-transitory computer-readable medium further comprises program instructions such that the computing system is configured to:
before streaming the at least part of the media content item to the at least one second user device, determining whether the at least one second user device is registered with the first media streaming service.

5. The computing system of claim 4, wherein streaming at least part of the media content item to the at least one second user device comprises:
based on a determination that the at least one second user device is registered with the first media streaming service, streaming the media content item to the at least one second user device.

6. The computing system of claim 4, wherein streaming at least part of the media content item to the at least one second user device comprises:
based on a determination that the at least one second user device is not registered with the first media streaming service, streaming a sample of the media content item to the at least one second user device.

7. The computing system of claim 1, wherein:
the at least one first user device is registered with a first computing system account which has access to a first media streaming service;
the media content item is a media content item provided by the first media streaming service; and
the at least one second user device is registered with a second computing system account which does not have access to the first media streaming service.

8. The computing system of claim 1, wherein streaming at least part of the media content item to the at least one second user device comprises:
obtaining the at least part of the media content item from a media streaming service external to the computing system; and
streaming the obtained at least part of the media content item to the at least one second user device.

9. The computing system of claim 1, wherein streaming at least part of the media content item to the at least one second user device comprises:
causing a media streaming service external to the computing system to stream the at least part of the media content item to the at least one second user device.

10. The computing system of claim 1, wherein:
the at least one non-transitory computer-readable medium further comprises program instructions such that the computing system is configured to communicate with a plurality of user devices registered with respective computing system accounts;
the user devices in the set of user devices are registered with respective computing system accounts that are enabled to share data between them; and
the plurality of user devices registered with respective computing system accounts comprise at least one additional user device which is not enabled to share data with the set of user devices.

11. The computing system of claim 1, wherein:
the at least one first user device is registered with a first computing system account;
the at least one second user device is registered with a second computing system account; and
the second computing system account is authorized to receive data from the first computing system account.

12. The computing system of claim 11, wherein:
the set of user devices comprises a third user device registered with a third computing system account;
the third computing system account is not authorized to receive data from the first computing system account; and
transmitting at least part of the second set of data comprises transmitting the at least part of the second set of data to the at least one second user device and forgoing transmitting the at least part of the second set of data to the third user device.

13. A non-transitory computer-readable medium having stored thereon instructions executable by one or more processors to cause a computing system to perform functions comprising:
transmitting a first set of data to a set of user devices, the first set of data corresponding to a prompt to be displayed by the set of user devices;
receiving, from at least one first user device in the set of user devices, a second set of data, the second set of data corresponding to a response to the prompt received via the at least one first user device, wherein the response comprises an indication of at least one media content item;
transmitting at least part of the second set of data to at least one second user device in the set of user devices to enable display, by the at least one second user device, of a graphical representation of the response to the prompt received via the at least one first user device;
receiving, from the at least one second user device, a third set of data corresponding to a selection received via the graphical representation; and
based on the third set of data, streaming at least part of the media content item to the at least one second user device.

14. The non-transitory computer-readable medium of claim 13, wherein:
the set of user devices are registered with respective computing system accounts; and
the graphical representation of the response to the prompt comprises an indication of a computing system account associated with the at least one first user device.

15. The non-transitory computer-readable medium of claim 13, wherein:
the at least one first user device is registered with a first media streaming service; and
the media content item is stored in a storage of the first media streaming service.

16. The non-transitory computer-readable medium of claim 15, having stored thereon instructions executable by the one or more processors to cause the computing system to perform functions comprising:
before streaming the at least part of the media content item to the at least one second user device, determining whether the at least one second user device is registered with the first media streaming service.

17. The non-transitory computer-readable medium of claim 16, wherein streaming at least part of the media content item to the at least one second user device comprises:
based on a determination that the at least one second user device is registered with the first media streaming service, streaming the media content item to the at least one second user device.

18. The non-transitory computer-readable medium of claim 16, wherein streaming at least part of the media content item to the at least one second user device comprises:
based on a determination that the at least one second user device is not registered with the first media streaming service, streaming a sample of the media content item to the at least one second user device.

19. The non-transitory computer-readable medium of claim 13, wherein:
the at least one first user device is registered with a first computing system account which has access to a first media streaming service;
the media content item is a media content item provided by the first media streaming service; and
the at least one second user device is registered with a second computing system account which does not have access to the first media streaming service.

20. A method to be performed by a computing system, the method comprising:
transmitting a first set of data to a set of user devices, the first set of data corresponding to a prompt to be displayed by the set of user devices;
receiving, from at least one first user device in the set of user devices, a second set of data, the second set of data corresponding to a response to the prompt received via the at least one first user device, wherein the response comprises an indication of at least one media content item;
transmitting at least part of the second set of data to at least one second user device in the set of user devices to enable display, by the at least one second user device, of a graphical representation of the response to the prompt received via the at least one first user device;
receiving, from the at least one second user device, a third set of data corresponding to a selection received via the graphical representation; and
based on the third set of data, streaming at least part of the media content item to the at least one second user device.
